(19) United States
(12) Patent Application Publication
(10) Pub. No.: US 2024/0040976 A1
(43) Pub. Date: Feb. 8, 2024

(54) PLANTING METHOD OF DENDROBIUMNOBILELINDL

(71) Applicants: Guiyang PENG, Haikou City, Hainan (CN); HAINAN DENDROBIUM HEALTH INDUSTRY CO.,LTD., Haikou City, Hainan (CN)

(72) Inventors: Guiyang PENG, Haikou City, Hainan (CN); Wanxing ZHANG, Haikou City, Hainan (CN); Wu LI, Haikou City, Hainan (CN); Xiangming NING, Haikou City, Hainan (CN); Xiaoping CHEN, Haikou City, Hainan (CN); Haisong FU, Haikou City, Hainan (CN); Guobing WU, Haikou City, Hainan (CN); Wei DENG, Haikou City, Hainan (CN)

(21) Appl. No.: 17/624,285

(22) PCT Filed: Dec. 27, 2021
(86) PCT No.: PCT/CN2021/141699

§ 371 Date: Jun. 7, 2023

(51) Int. Cl. A01G 22/63; A01G 13/00; A01G 9/12; C05F 3/00

(52) U.S. Cl. CPC A01G 22/63; A01G 13/00; A01G 9/128; C05F 3/00

(57) ABSTRACT

The invention relates to a planting method of DendrobiumnobileLindl, it comprises the following steps: Selecting betel palm trees that are more than 5 years old or or more than 6 meters high; Selecting the DendrobiumnobileLindl seedlings with a height of more than 12 cm, with 1 or 2 new buds and complete roots, stems and leaves, and dividing DendrobiumnobileLindl seedlings into 2-4 clumps a group; Combing and aligning the roots of each group of DendrobiumnobileLindlseedlings, taking one group of DendrobiumnobileLindl seedlings and sticking them to the knot of the betel plain tree each time, then using a cotton rope or a tie to wind and fix the DendrobiumnobileLindl seedlings on the betel palm tree trunk from the stems of each group of DendrobiumnobileLindl seedlings; Putting the roots below the stembase of the DendrobiumnobileLindlseedling on the betel palm tree trunk and smearingdendrobium nutrient. It solves the technical problem that the trunks and branches of the tree species selected by the existing methods of planting by sticking trees are not flat enough, it is not easy to fix the Dendrobiumnobile seedlings, and at the same time, it is necessary to destroy the trees planted with dendrobium and cause damage to the trees.

### TECHNICAL FIELD

The invention relates to the technical field of Dendrobium planting, in particular to a planting method of DendrobiumnobileLindl.

### BACKGROUND ART

Dendrobiumnobilelindl, also known as chlorophytumcomosum, it is a common and precious Chinese medicinal material. Dendrobium is used as medicine with stems. It is cold in nature and sweet in taste. It has the effects of invigorating the stomach, nourishing fluid, nourishing yin and clearing away heat. It can be used to treat diseases such as fever, thirst, asthenic heat after illness, light tongue with little fur, scanty food, retching, dim eyesight and so on.

DendrobiumnobileLindl is epiphytic, prefers a dark and humid environment, requires high air humidity and broad-leaved sparse forest shade, the cultivation site should select the place where the rocks are relatively concentrated, with the stony is friable and rough, easy to absorb moisture, and has moss growing stones; pasting trees are based on live trees with thick bark, longitudinal grooves, lush leaves, and thick trunks, such as yellow pine trees, capillaries, and tongzi trees, they are usually cut a shallow gap on the relatively flat and thick branch or trunk with a knife, and fixing the base of the processed dendrobium on the gap with bamboo nails or ribbons, and then cow dung is applied to the root of the dendrobium to make the new roots grow tightly along the tree body, the trunks and branches of the tree species selected by these existing methods of planting by sticking trees are not flat enough to fix DendrobiumnobileLindl seedlings, at the same time it is necessary to destroy the trees for planting dendrobium and cause damage to the trees.

### SUMMARY OF THE INVENTION

In order to solve the shortcomings of the existing technology, the present invention provides a planting method of DendrobiumnobileLindl, it comprises the following steps:
selecting betel palm trees that are more than 5 years old or higher than 6 meters;
selecting the DendrobiumnobileLindl seedlings that higher than 12 cm, with 1 or 2 new buds and complete roots, stems and leaves, and dividing DendrobiumnobileLindl seedlings into 2-4 clumps a group;
combing and aligning the roots of each group of DendrobiumnobileLindlseedlings, taking one group of DendrobiumnobileLindl seedlings and sticking them to the knot of the betel plain tree each time, then using a cotton rope or a tie to wind and fix the DendrobiumnobileLindl seedlings on the betel palm tree trunk from the stems of each group of DendrobiumnobileLindl seedlings;
putting the roots below the stem base of the DendrobiumnobileLindlseedling on the betel palm tree trunk and smearingdendrobium nutrient.

Optionally the dendrobium nutrient is decaying cow dung, the amount of the cow dung smeared is 100 g.

Optionally the of the cow dung smeared area is 0.2 square meters.

Optionally each group of DendrobiumnobileLindl are planted on betel palm trees at intervals of 2-3 knots.

Optionally combing and aligning the roots of each group of DendrobiumnobileLindlseedlings, taking one group of DendrobiumnobileLindl seedlings and sticking them to the knot of the betel plamtree each time, then using a cotton rope or a tie to wind and fix the DendrobiumnobileLindl seedlings on the betel palm tree trunk from the stems of each group of DendrobiumnobileLindl seedlings, comprising:
combing and aligning the roots of each group of DendrobiumnobileLindlseedlings;
taking one group of DendrobiumnobileLindl seedlings and sticking them to the knot of the betel plain tree, and using a cotton rope or a tie to wind and fix the DendrobiumnobileLmdl seedlings on the betel palm tree trunk from the stems of each group of DendrobiumnobileLindl seedlings;
using another cotton rope or tie to wind and fix the DendrobiumnobileLindl seedlings on the betel palm tree trunk from the root of each group of DendrobiumnobileLindl seedlings 1 cm below the stem base.

Optionally the cotton rope is cotton rope, the cotton rope is woven from 9 strands of cotton thread with a diameter of 1.5 mm.

Optionally the cotton rope or tie used to fix DendrobiumnobileLindl on the betel palm tree trunk from the stem of the DendrobiumnobileLindl seedling, when it is on the betel palm tree trunk, there is a gap for the activities of DendrobiumnobileLindlseedlings between the cotton rope or tie and the betel palm tree trunk; the cotton rope or tie used to fix DendrobiumnobileLindl on the betel palm tree trunk from the root of each group of DendrobiumnobileLindl seedlings 1 cm below the stem base, when it is on the betel palm tree trunk, there is no gap for the activities of DendrobiumnobileLindl seedlings between the cotton rope or tie and the betel palm tree trunk.

Optionally the stem of the DendrobiumnobileLindl seedling is aligned 2 cm above the stem knot of the betel palm tree.

Optionally choosing betel palm trees that are more than 5 years old or higher than 6 meters comprises:
selecting betel palm trees that are more than 5 years old or higher than 6 meters in betel palm planting areas with a distance of 2 meters to 3 meters between betel palm trees and no less than 110 betel palm trees.

Optionally the planting position of each group of DendrobiumnobileLindl seedlings is at least 1 meter from the ground.

This application provides a planting method of DendrobiumnobileLindl, using betel palm tree as the growth carrier of DendrobiumnobileLindlseedlings, using the characteristics of betel palm tree to grow straight and without branches, and only need to use tying lines or ties to fix the DendrobiumnobileLindl seedlings on the betel palm tree for growing on their own without destroying the planted tree. The fixing method is simple, and the DendrobiumnobileLindlseedlings are epiphytic growing on the betel palm trees, the later maintenance of DendrobiumnobileLindl is relatively simple and there is no affects for the harvest of betel nut at the same time. Therefore, it solves the technical problem that the trunks and branches of the tree species selected by the existing methods of planting by sticking trees are not smooth enough, and it is not easy to fix the Dendrobiumnobile seedlings, at the same time, it is necessary to destroy the trees planted with dendrobium and cause damage to the trees.

### BRIEF DESCRIPTION OF THE DRAWINGS

In order to more clearly describe the technical solutions in the embodiments of the present application, the following will briefly introduce the drawings used in the description of the embodiments, obviously, the drawings in the following description are only some of the implementations recorded in the present application, for those of ordinary skill in the art, other drawings can be obtained based on these drawings.

FIG. 1 is a schematic flow diagram of a planting method of DendrobiumnobileLindl provided in the embodiments of the application;

FIG. 2 is another schematic flow diagram of a planting method of DendrobiumnobileLindl provided in the embodiments of the application;

FIG. 3 is a schematic diagram of DendrobiumnobileLindl seedlings planted on a betel palm tree provided in an embodiment of the application

1. stem base; 2. betelpalm tree; 3. stem; 4. root; 5. dendrobium nutrient.

### DETAILED DESCRIPTION OF SOME EMBODIMENTS

In order to have a better understanding of the technical solutions and beneficial effects of the present invention, the technical solutions of the present invention and the beneficial effects produced will be described in detail below with reference to the accompanying drawings.

### Embodiment 1

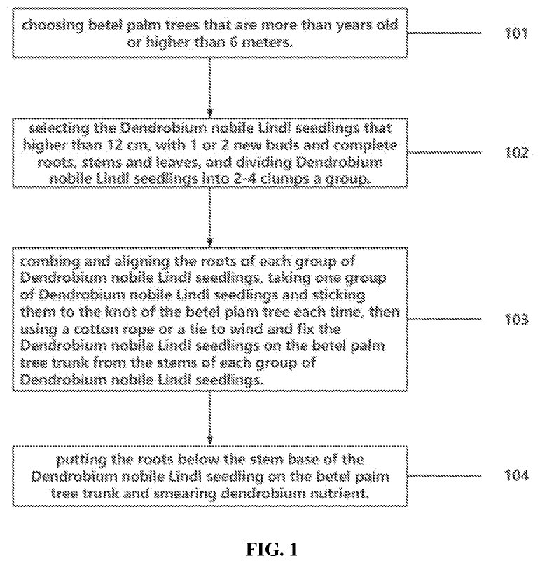

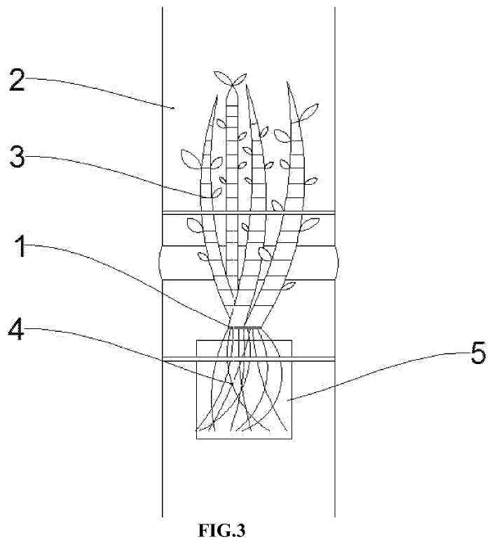

For ease of understanding, as shown in FIG. 1 and FIG. 3, this application provides an embodiment of a planting method of DendrobiumnobileLindl, which includes the following steps:

Step 101: selecting betel palm trees 2 that are more than 5 years old or higher than 6 meters.

In order not to affect the development of the betel palm tree 2 and at the same time growing a sufficiently tall betel palm tree 2 to facilitate the attachment of DendrobiumnobileLindl seedlings, therefore, the betel palm tree 2 of more than 5 years or more than 6 meters is selected as the planting carrier in the embodiments of this application.

Step 102: selecting the DendrobiumnobileLindl seedlings that higher than 12 cm, with 1 or 2 new buds and complete roots, stems and leaves, and dividing DendrobiumnobileLindl seedlings into 2-4 clumps a group.

In order to improve the survival rate of Dendrobiumnobile seedlings, this example selects DendrobiumnobileLindl seedlings with a height of 12 cm or more, with 1 or 2 new buds, and complete roots, stems and leaves. It should be noted that the selected DendrobiumnobileLindl seedlings are disease-free, Sturdy DendrobiumnobileLindl seedlings without pest damage and mildew; and then grouped 2-4 clumps of DendrobiumnobileLindl seedlings as a group. In order to increase the utilization rate of the trunk and increase the yield of Dendrobium, it is preferable to group 4 clumps of Dendrobiumnobile seedlings as a group.

Step 103: combing and aligning the roots 4 of each group of DendrobiumnobileLindlseedlings, taking one group of DendrobiumnobileLindl seedlings and sticking them to the knot of the betel plain tree 2 each time, then using a cotton rope or a tie to wind and fix the DendrobiumnobileLindl seedlings on the betel palm tree 2 trunk from the stems of each group of DendrobiumnobileLindl seedlings.

Combing and aligning the roots 4 of each group of DendrobiumnobileLindl seedlings to facilitate uniform fixation of DendrobiumnobileLindl seedlings, and taking a group of DendrobiumnobileLindl seedlings each time and sticking them to a section of the betel palm tree 2, using a cotton rope or a tie to wind fix the DendrobiumnobileLindl seedlings from the stems of each group of DendrobiumnobileLindl seedlings to the trunks of the betel palm tree 2.

Step 104: putting the roots 4 below the stem base 1 of the DendrobiumnobileLindlseedling on the betel palm tree 2 trunk and smearingdendrobium nutrient 5.

In order to provide nutrients for dendrobiumnobileLindlseedlings in the early stage to better adhere to betel palm tree 2, the root 4 below the stem base 1 of DendrobiumnobileLindlseedlings was attached to the trunk of the betel palm tree 2 to apply dendrobium nutrient 5, preferably at 1 cm below the stem base 1.

This application provides a planting method of DendrobiumnobileLindl, using betel palm tree 2 as the growth carrier of DendrobiumnobileLindl seedlings, using the characteristics of betel palm tree 2 to grow straight and without branches, and only need to use tying lines or ties to fix the DendrobiumnobileLindl seedlings on the betel palm tree 2 for growing on their own without destroying the planted tree. The fixing method is simple, and the DendrobiumnobileLindl seedlings are epiphytic growing on the betel palm trees2, the later maintenance of DendrobiumnobileLindl is relatively simple and there is no affects for the harvest of betel nut at the same time. Therefore, it solves the technical problem that the trunks and branches of the tree species selected by the existing methods of planting by sticking trees are not smooth enough, and it is not easy to fix the Dendrobiumnobile seedlings, at the same time, it is necessary to destroy the trees planted with dendrobium and cause damage to the trees.

### Embodiment 2

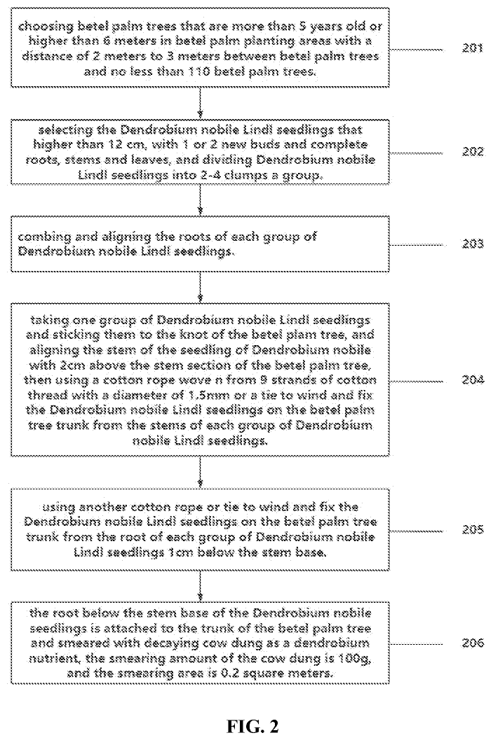

As a further improvement to Embodiment 1, as shown in FIGS. 2 to 3, this embodiment includes the following steps:

Step 201: choosing betel palm trees 2 that are more than 5 years old or higher than 6 meters in betel palm planting areas with a distance of 2 meters to 3 meters between betel palm trees 2 and no less than 110 betel palm trees.

For the balanced distribution of environmental resources, it is conducive to the overall growth of Dendrobium, choosing betel palm trees 2 that are more than 5 years old or higher than 6 meters in betel palm planting areas with a distance of 2 meters to 3 meters between betel palm trees and no less than 110 betel palm trees 2.

Step 202: selecting the DendrobiumnobileLindl seedlings that higher than 12 cm, with 1 or 2 new buds and complete roots, stems and leaves, and dividing DendrobiumnobileLindl seedlings into 2-4 clumps a group.

In order to improve the survival rate of Dendrobiumnobile seedlings, this example selects DendrobiumnobileLindl seedlings with a height of 12 cm or more, with 1 or 2 new buds, and complete roots, stems and leaves. It should be noted that the selected DendrobiumnobileLindl seedlings are disease-free, Sturdy DendrobiumnobileLindl seedlings without pest damage and mildew; and then grouped 2-4 clumps of DendrobiumnobileLindl seedlings as a group. In order to increase the utilization rate of the trunk and increase the yield of Dendrobium, it is preferable to group 4 clumps of Dendrobiumnobile seedlings as a group.

Step 203: combing and aligning the roots 4 of each group of DendrobiumnobileLindl seedlings.

Step 204: taking one group of DendrobiumnobileLindl seedlings and sticking them to the knot of the betel plain tree 2, and aligning the stem 3 of the seedling of Dendrobiumnobile with 2 cm above the stem section of the betel palm tree 2, then using a cotton rope woven from 9 strands of cotton thread with a diameter of 1.5 mm or a tie to wind and fix the DendrobiumnobileLindl seedlings on the betel palm tree 2 trunk from the stems 3 of each group of DendrobiumnobileLindl seedlings.

Step 205: using another cotton rope or tie to wind and fix the DendrobiumnobileLindl seedlings on the betel palm tree 2 trunk from the root 4 of each group of DendrobiumnobileLindl seedlings 1 cm below the stem base 1.

In one embodiment, the stem 3 of the Dendrobiumnobile seedling is aligned with the cotton rope or tie 2 cm above the stem section of the betel palm tree 2 and there is a gap for the movement of the Dendrobiumnobile seedling on the stem, there is no gap between the cotton rope or tie of the root 4 at least 1 cm below the stem base 1 and the trunk of betel palm tree 2 for the activities of Dendrobiumnobile seedlings. In one embodiment, the planting position of the tree-attached tree of the lowest group of Dendrobiumnobile seedlings is at least 1 meter away from the ground, and each group of Dendrobiumnobile seedlings is planted at intervals of 2-3 knots of the betel palm tree 2.

It should be noted that in step 203 to step 205, each group of DendrobiumnobileLindl seedlings needs to be combed and aligned, and a group of DendrobiumnobileLindl seedlings should be attached to a section of betel palm tree 2, in order to prevent Dendrobiumnobile seedlings from being too close to the ground to die from being stained by soil splashed by rain, the position where the DendrobiumnobileLindl seedlings are attached to the tree should be at least 1 meter away from the ground, and then the stem 3 of the DendrobiumnobileLindl seedlings should be aligned with the stem 3 of the betel palm tree 2 cm above the stem section, as shown in the FIG. 3, the use of the bulge in the position of the knot of trunk can prevent the DendrobiumnobileLindl seedlings from slipping off during fixation; in order to ensure that the DendrobiumnobileLindl seedlings can be attached to the trunk, a cotton rope woven from 9 strands of 1.5 mm diameter cotton thread or a tie is used towing and fix the DendrobiumnobileLindl seedlings on the trunk of the betel palm tree 2 from the stem 3 of each group of DendrobiumnobileLindl seedlings, and there is a gap between the cotton rope or tie and the trunk of the betel palm tree 2 for the activities of the DendrobiumnobileLindlseedlings, in order to make it easy to move the DendrobiumnobileLindlseedlings to distribute them evenly on the trunk, then using another cotton rope or tie to wind and fix the DendrobiumnobileLindl seedlings on trunk of the betel palm tree 2 from the root 4 of each group of DendrobiumnobileLindl seedlings 1 cm below the stem base 1, and there is no gap between the cotton rope or tie and the trunk of betel palm tree 2 for the movement of DendrobiumnobileLindlseedlings, so that the root 4 is close to the trunk, which is beneficial for the DendrobiumnobileLindlseedlings to attach to the trunk. In addition, each group of DendrobiumnobileLindlseedlings is planted at intervals of 2 to 3 knots of the betel palm tree 2, which effectively increases the planting amount of DendrobiumnobileLindlseedlings, in this embodiment, it is preferable to plant a group of DendrobiumnobileLindl seedlings at intervals of 2 knots, which can increase the planting amount of DendrobiumnobileLindl to increase the yield.

Step 206: the root 4 below the stembase 1 of the DendrobiumnobileLindlseedlings is attached to the trunk of the betel palm tree 2 and smeared with decaying cow dung as a dendrobium nutrient 5, the smearing amount of the cow dung is 100 g, and the smearing area is 0.2 square meters.

In order to provide nutrients for DendrobiumnobileLindl seedlings in the early stage to better adhere to betel palm tree 2, the root 4 below the stem base 1 of DendrobiumnobileLindl seedlings was attached to the trunk of the betel palm tree 2 to apply dendrobium nutrient 5, preferably at a distance of 1 cm or less from the stem base 1.

Although the present invention has been described using the above-mentioned preferred embodiments, it is not intended to limit the scope of protection of the present invention, anyone skilled in the art can make various changes and modifications to the above-mentioned embodiments without departing from the spirit and scope of the present invention, and that still belong to the scope of protection of the present invention, so the protection scope of the present invention is defined by the claims.

1. A planting method of DendrobiumnobileLindl, charactered in that it comprises the following steps:
Selecting betel palm trees that are more than 5 years old or higher than 6 meters;
selecting the DendrobiumnobileLindl seedlings with a height of more than 12 cm, with 1 or 2 new buds and complete roots, stems and leaves, and dividing DendrobiumnobileLindl seedlings into 2-4 clumps a group;
combing and aligning the roots of each group of DendrobiumnobileLindlseedlings, taking one group of DendrobiumnobileLindl seedlings and sticking them to the knot of the betel plain tree each time, then using a cotton rope or a tie to wind and fix the DendrobiumnobileLindl seedlings on the betel palm tree trunk from the stems of each group of DendrobiumnobileLindl seedlings;
putting the roots below the stem base of the DendrobiumnobileLindlseedling on the betel palm tree trunk and smearingdendrobium nutrient.

2. The planting method of DendrobiumnobileLindl of claim 1, charactered in that the dendrobium nutrient is decaying cow dung, the amount of the cow dung smeared is 100 g.

3. The planting method of DendrobiumnobileLindl of claim 2, charactered in that the of the cow dung smeared area is 0.2 square meters.

4. The planting method of DendrobiumnobileLindl of claim 1, charactered in that each group of DendrobiumnobileLindl are planted on betel palm trees at intervals of 2-3 knots.

5. The planting method of DendrobiumnobileLindl of claim 1, charactered in that combing and aligning the roots of each group of DendrobiumnobileLindlseedlings, taking one group of DendrobiumnobileLindl seedlings and sticking them to the knot of the betel plain tree each time, then using a cotton rope or a tie to wind and fix the DendrobiumnobileLindl seedlings on the betel palm tree trunk from the stems of each group of DendrobiumnobileLindl seedlings, comprising:
combing and aligning the roots of each group of DendrobiumnobileLindlseedlings;
taking one group of DendrobiumnobileLindl seedlings and sticking them to the knot of the betel plain tree, and using a cotton rope or a tie to wind and fix the DendrobiumnobileLmdl seedlings on the betel palm tree trunk from the stems of each group of DendrobiumnobileLindl seedlings;
using another cotton rope or tie to wind and fix the DendrobiumnobileLindl seedlings on the betel palm tree trunk from the root of each group of DendrobiumnobileLindl seedlings 1 cm below the stem base.

6. The planting method of Dendrobiumnobile according to any one of claims 1-5, charactered in that the cotton rope is cotton rope, the cotton rope is woven from 9 strands of cotton thread with a diameter of 1.5 mm.

7. The planting method of DendrobiumnobileLindl of claim 5, charactered in that the cotton rope or tie used to fix DendrobiumnobileLindl on the betel palm tree trunk from the stem of the DendrobiumnobileLindl seedling, when it is on the betel palm tree trunk, there is a gap for the activities of DendrobiumnobileLindl seedlings between the cotton rope or tie and the betel palm tree trunk; the cotton rope or tie used to fix DendrobiumnobileLindl on the betel palm tree trunk from the root of each group of DendrobiumnobileLindl seedlings 1 cm below the stem base, when it is on the betel palm tree trunk, there is no gap for the activities of DendrobiumnobileLindl seedlings between the cotton rope or tie and the betel palm tree trunk.

8. The planting method of DendrobiumnobileLindl of claim 5, charactered in that the stem of the DendrobiumnobileLindl seedling is aligned 2 cm above the stem knot of the betel palm tree.

9. The planting method of DendrobiumnobileLindl of claim 1, charactered in that choosing betel palm trees that are more than 5 years old or higher than 6 meters comprises:

10. Selecting betel nut trees for more than 5 years or more than 6 meters from betel nut planting fields with the distance between betel nut trees of 2-3 meters and no less than 110 betel nut trees. The planting method of DendrobiumnobileLindl of claim 1, charactered in that the planting position of each group of DendrobiumnobileLindl seedlings is at least 1 meter from the ground.
